(19) United States
(12) Patent Application Publication
(10) Pub. No.: US 2014/0105803 A1
(43) Pub. Date: Apr. 17, 2014

(54) METHOD FOR PREPARING CATALYST FOR REMOVING NITROGEN OXIDES USING DRY BALL MILLING

(71) Applicants: Sung Ho Hong, Seoul (KR); Sung Pill Cho, Yongin-si (KR); Chang Hoon Shin, Seongnam-si (KR); Bok Yeon Yang, Yongin-si (KR); Sang Woo Shin, Seoul (KR); Sung Chang Hong, Seoul (KR); Kwang Hee Park, Suwon-si (KR); Sung Su Kim, Suwon-si (KR); Sang Moon Lee, Suwon-si (KR); Dong Wook Kwon, Seoul (KR)

(72) Inventors: Sung Ho Hong, Seoul (KR); Sung Pill Cho, Yongin-si (KR); Chang Hoon Shin, Seongnam-si (KR); Bok Yeon Yang, Yongin-si (KR); Sang Woo Shin, Seoul (KR); Sung Chang Hong, Seoul (KR); Kwang Hee Park, Suwon-si (KR); Sung Su Kim, Suwon-si (KR); Sang Moon Lee, Suwon-si (KR); Dong Wook Kwon, Seoul (KR)

(73) Assignee: KEPCO ENGINEERING & CONSTRUCTION COMPANY, INC., Yongin-si, Gyeonggi-do (KR)

(21) Appl. No.: 14/116,875

(22) PCT Filed: May 22, 2012
(86) PCT No.: PCT/KR2012/004024

§ 371 Date: Nov. 11, 2013

(30) Foreign Application Priority Data
Jun. 27, 2011 (KR) 10-2011-0062201

(51) Int. Cl. B01J 23/28; B01D 53/56; B01J 23/22

(52) U.S. Cl. CPC B01J 23/28; B01J 23/22; B01D 53/565
USPC 423/239.1; 502/350; 502/309; 502/303

(57) ABSTRACT

Disclosed is a method for preparing a deNOx catalyst for removing nitrogen oxides (NOx) included in exhaust gas and the like. One embodiment of the present invention discloses a V₂O₅(vanadium pentoxide)-TiO₂(titanium dioxide)-based deNOx catalyst for removing nitrogen oxides through selective catalytic reduction by dry-ball-milling crystalline titanium dioxide (TiO₂) powder and crystalline vanadium pentoxide (V₂O₅) powder.

### TECHNICAL FIELD

The present invention relates to a method of preparing a catalyst for removing nitrogen oxides using dry ball milling More particularly, the present invention relates to a method of preparing a denitrification catalyst, which can be applied to a selective catalytic reduction (SCR) technology for removing nitrogen oxides inevitably generated in the process of burning fossil fuel and wastes by dry-ball-milling crystalline vanadium pentoxide (V₂O₅) and crystalline titanium dioxide (TiO₂).

### BACKGROUND ART

Nitrogen oxide (NOₓ) discharged from the combustion of fossil fuel is known as a major air pollutant causing photochemical smog, ozone layer destruction and global warming. Therefore, NOx-related environmental regulations have recently become stricter, so an environment-friendly and economical novel high-efficiency NOx removing system has become increasingly required in order to cope with stricter environmental regulations, and thus various methods for removing nitrogen oxides have been developed and used. Among these methods, catalytic methods are widely used because of low cost and high efficiency. One of the most effective methods of removing nitrogen oxides is selective catalytic reduction (SCR) using ammonia as a reducing agent. A general SCR reaction is expressed as follows.

4NO+4NH₃+O₂→4N₂+6H₂O [Reaction Formula 1]

2NO₂+4NH₃+O₂→3N₂+6H₂O [Reaction Formula 2]

NO+NO₂+2NH₃→2N₂+3H₂O [Reaction Formula 3]

This SCR reaction is conducted under a denitrification catalyst, that is, a SCR catalyst. As a commercially available SCR catalyst, a V/TiO₂ catalyst including titanium dioxide (TiO₂) as a support and vanadium (V) as an active metal is used. In order to improve the durability and performance of a SCR catalyst, generally, titanium dioxide (TiO₂) contains tungsten (W) or molybdenum (Mo).

The most widely known method of preparing a V/TiO₂ catalyst is a wet impregnation method. This method is as follows. First, a vanadium precursor is dissolved in a predetermined amount of water to obtain an aqueous vanadium precursor solution. Generally, ammonium metavanadate (NH₄VO₃) is used as the vanadium precursor. Subsequently, titanium dioxide (TiO₂), as a support, is sufficiently mixed with the aqueous vanadium precursor solution, dried and then calcined to prepare a V/TiO₂ catalyst. This method is generally used in preparing an industrial catalyst because the content of vanadium (V) can be easily adjusted and a V/TiO₂ catalyst can be prepared in large quantities.

However, the state of the supported (or impregnated) active material exposed on surface greatly varies depending on multiple factors including the solubility of the vanadium precursor, the pH of the aqueous vanadium precursor solution, and drying and calcinations conditions, resulting in a change in the performance of the catalyst obtained. Particularly, it is very difficult to prepare the aqueous vanadium precursor solution. That is, water must be heated in order to increase the solubility of ammonium metavandate, oxalic acid ((COOH)₂) must be added, and a neutralizing agent must be added in order to adjust the pH of the aqueous vanadium precursor solution. In other words, many operations and additives are required. Further, a large amount of power is necessary for mixing the aqueous vanadium precursor solution with titanium dioxide. When the amount of water in the aqueous solution is large, vanadium is uniformly distributed on the surface of titanium dioxide to increase dispersity, but a large amount of heat is required at the time of drying the aqueous solution. Conversely, when the amount of water in the aqueous precursor solution is small, small amount of heat is required at the time of drying the aqueous precursor solution, but sufficient time is required to realize uniform dispersion because titanium dioxide is not easily mixed with a precursor. Further, when titanium dioxide is mixed with the aqueous precursor solution, the viscosity of the mixture is changed according to the amount of water, thus influencing the electric power of a mixer. As such, in the wet impregnation method, since powdered raw materials are wet-mixed, dried and then calcined, an apparatus for supplying purified water and a drying apparatus for vaporizing the purified water are required. Further, an apparatus for preparing an aqueous vanadium precursor solution is also required, thus increasing production cost. Further, when a catalyst is calcined, various side products are formed from additives including ammonium metavanadate, and thus an apparatus for treating the side products is required.

In order to solve the above problems, in the present invention, a denitrification catalyst is prepared by ball milling. Ball milling has been used in synthesizing various stable or quasi-stable materials including crystalline and quasi-crystalline amorphous alloys since it was used in producing oxygen-dispersed nickel alloys in the 1960's. For example, Japanese Patent No. 2824507 discloses a method of preparing titanium-aluminum-based intermetallic compound powder used as a light heat-resistant material by ball-milling titanium powder and aluminum powder in a mill container.

Researches into applying ball milling to ceramics, polymers and composite materials as well as metals have been conducted since 1990's. Currently, ball milling is used even in the process of preparing a catalyst. U.S Patent Application Publication No. 2009-0060810 A1 (Korean Patent Application Publication No. 2007-99177) discloses a method of preparing a selective reduction catalyst for denitrification using wet ball-milling, including the steps of: providing an aqueous vanadium precursor solution; adding a titania support to the aqueous solution to form a slurry; drying the slurry; and ball-milling and then calcining the dried slurry or calcining and then ball-milling the dried slurry. In the case of such wet ball milling, an aqueous precursor solution must be additionally prepared, and a process of adding titanium oxide to the aqueous precursor solution to remove slurry and then drying the aqueous precursor solution is required.

### DISCLOSURE

### Technical Problem

An object of the present invention is to provide a method of efficiently preparing a denitrification catalyst using a simple process, compared to conventional wet impregnation or wet ball milling.

Another object of the present invention is to provide a method of preparing a denitrification catalyst, which can exhibit equal or excellent performance using a small amount of vanadium, compared to conventional wet impregnation.

### Technical Solution

In order to accomplish the above objects, an aspect of the present invention provides a method of preparing a catalyst for removing nitrogen oxides, including the steps of: mixing crystalline titanium dioxide (TiO₂) powder and crystalline vanadium pentoxide (V₂O₅) powder to obtain a mixture; subjecting the mixture to a dry ball milling process; and calcining the ball-milled mixture.

The catalyst manufactured by this method can be used in various fields. For example, this catalyst can be used in selective catalytic reduction for removing nitrogen oxides included in exhaust gas.

### Advantageous Effects

The method of preparing a denitrification catalyst using vanadium and titanium dioxide according to the present invention is simple compared to a conventional method of preparing a denitrification catalyst by wet impregnation. Therefore, according to the present invention, the time required to prepare a catalyst can be shortened, and the cost for preparing a catalyst can be reduced. Further, the method of preparing a denitrification catalyst according to the present invention exhibits an excellent denitrification ability compared to a conventional method of preparing a denitrification catalyst using the same amount of vanadium, thus reducing the cost for installing denitrification equipment.

### DESCRIPTION OF DRAWINGS

FIG. 1 is a schematic view showing a method of preparing a catalyst using dry ball milling according to an embodiment of the present invention.

FIG. 2 is a schematic view showing a conventional method of preparing a catalyst using wet impregnation.

FIG. 3 is a schematic view showing a process of preparing a catalyst without using ball milling according to Comparative Preparation Example 7.

FIG. 4 is a graph showing the results of X-ray diffraction (XRD) analysis of a catalyst prepared according to an Example of the present invention.

### BEST MODE

The present invention provides a method of preparing a catalyst for removing nitrogen oxides, including the steps of: mixing crystalline titanium dioxide (TiO₂) powder and crystalline vanadium pentoxide (V₂O₅) powder to obtain a mixture; subjecting the mixture to a dry ball milling process; and calcining the ball-milled mixture.

According to an embodiment of the present invention, the crystalline titanium dioxide (TiO₂) may be in the form of anatase crystals or in the form of anatase/rutile mixed crystals. Specifically, the crystalline titanium dioxide (TiO₂) may be a mixture in which anatase crystals and rutile crystals are mixed at a weight ratio of 70:30˜100:0.

According to an embodiment of the present invention, in order to improve the performance and durability of the catalyst, at least one co-catalyst selected from the group consisting of tungsten, molybdenum and lanthanum may be added. According to an embodiment of the present invention, the crystalline titanium dioxide (TiO₂) may additionally include at least one selected from the group consisting of WO₃, MoO₃, and LaO₃ in an amount of 1 to 10 wt % based on the content of TiO₂.

According to an embodiment of the present invention, the crystalline vanadium pentoxide (V₂O₅) may be used in an amount of 0.1˜5 wt %, as a calculated value of vanadium atom, based on the total weight of the crystalline titanium dioxide (TiO₂).

As used herein, the term “crystalline vanadium pentoxide” is intended to differentiate from amorphous vanadium pentoxide, and encompass all crystalline, powdered phases of vanadium pentoxide commonly used in the art.

As used herein, the term “powdered” is intended to differentiate from and exclude a solution state, and encompass any type of powdered titanium dioxide or vanadium pentoxide if it is commonly used in the art, without particular limitations to sizes and shapes of the powder.

In the present invention, the quality and size of ball and the ball milling conditions are not particularly limited. According to an embodiment of the present invention, the step of subjecting the mixture to a dry ball milling process may be performed at a ball powder mass ratio (BPMR) of 1:1˜100:1 at a rotation speed of 10˜1000 rpm for 0.5˜24 hours. According to an embodiment of the present invention, the step of subjecting the mixture to a dry ball milling process may be performed for 3˜24 hours. The dry ball milling process will be described in detail in the following Preparation Examples, but is not limited thereto. The present invention can be realized according to ball milling commonly used in the related field.

Further, the step of calcining the ball-milled mixture may be carried out according to the method and condition commonly used in the related field. Typically, the step of calcining the ball-milled mixture may be performed at a temperature of 300˜800° C. for 4˜12 hours under an air or oxygen atmosphere. In this calcining process, a tube-type furnace, a convection-type furnace, a fire grate-type furnace, a rotary kiln furnace or the like may be used, but is not limited thereto.

As will be understood later, the method of preparing the catalyst using dry ball milling according to the present invention has economical advantage over conventional wet impregnation method because it does not require an additional facility or process.

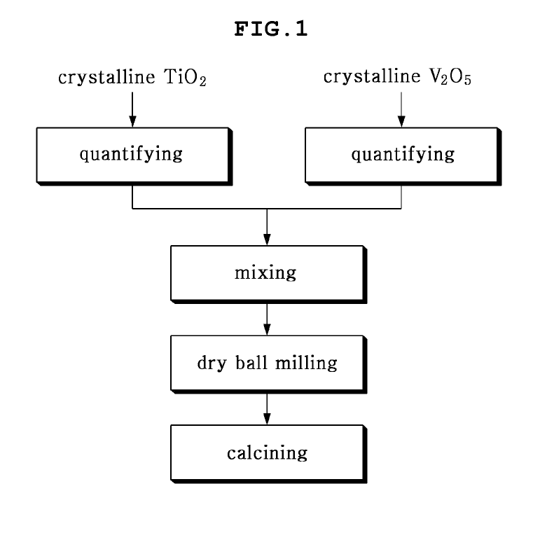

The wet impregnation method needs purified water for dissolving ammonium metavanadate and an apparatus therefor. Further, purified water must be heated in order to increase the solubility of ammonium metavanadate, and, in this case, an apparatus and heat source or power for heating the purified water is required. Further, since the pH of an aqueous ammonium metavanadate solution must be adjusted in order to prevent the precipitation of the aqueous solution, a pH adjuster, such as oxalic acid or the like, an apparatus for injecting the pH adjuster and an apparatus for storing the pH adjuster are required Ammonium metavanadate is mixed with a TiO₂ support in the aqueous solution to form a mixture, and this mixture has viscosity, so this mixture requires still more electric power than a mixture of solvent or powder. Additionally, a drying furnace for drying this mixture and a heat source or electric power necessary for drying the mixture are required. However, as described above, the method of preparing a catalyst for removing nitrogen oxides according to the present invention uses a simple process in which crystalline TiO₂ powder is used as a support, crystalline V₂O₅ powder is used as an active material and these two crystalline materials are ball-milled. Therefore, the method of the present invention is very economically efficient in that an additional apparatus or heat source used in the above-mentioned wet impregnation method is not required (refer to FIG. 1).

The denitrification catalyst prepared by the method of the present invention can be effectively used in removing nitrogen oxides included in exhaust gas. Therefore, another aspect of the present invention provides a method of removing nitrogen oxides from exhaust gas containing nitrogen oxides using selective catalytic reduction in the presence of the catalyst prepared by the method and a reducing agent.

According to an embodiment of the present invention, exhaust gas containing nitrogen oxides is selectively catalytic-reduced at a temperature of 150˜450° C. and a gas hourly space velocity (GHSV) of 1,000˜120,000 hr⁻¹ in the presence of the catalyst prepared by the method of present invention and ammonia as a reducing agent. In order to remove nitrogen oxides by the selective catalytic reduction reaction, ammonia is typically used as a reducing agent, and, in this case, the molar ratio of NH₃/NOx may be adjusted in the range of 0.6˜1.2. The kind of an ammonia source used as a reducing agent is not particularly limited as long as it can be converted into ammonia during a selective catalytic reduction reaction and can participate in the selective catalytic reduction reaction. For example, the ammonia source may be ammonia water, ammonia gas or urea.

### MODE FOR INVENTION

Hereinafter, the present invention will be described in more detail with reference to the following Examples. These Examples are set forth to illustrate the present invention, and the scope of the present invention is not limited thereto.

### EXAMPLES

In the following Preparation Examples 1 to 7, catalysts are prepared according to a process shown in FIG. 1.

### Preparation Example 1

### Preparation of V[2]-TiO₂(A)_BM Catalyst

TiO₂ (hereinafter, referred to as TiO₂(A)), crystalline phase of which is anatase, was used as a support. 20 g of titanium dioxide (TiO₂(A)) powder was provided. Additionally, 0.7142 g of crystalline vanadium pentoxide (V₂O₅) powder was provided such that the crystalline vanadium pentoxide (V₂O₅) is used in an amount of 2 wt %, as a calculated value of vanadium atom, based on a total weight of the titanium dioxide (TiO₂). These two raw materials were introduced into a ball milling machine together with balls. The balls were made of zirconia. The balls respectively having diameters of 20 mm, 10 mm and 5 mm were introduced into the ball milling machine at a weight ratio of 50:25:25. In this case, BPMR (ball to powder mass ratio, weight ratio of balls and a powder mixture) was 50:1. Ball milling was carried out at a rotation speed of 340 rpm for 3 hours. After the ball milling, the powder mixture was calcined in a tube furnace at 400° C. for 4 hours under an air atmosphere. In this case, the heating rate of the powder mixture was 10° C./min. The catalyst prepared in this way is expressed by “V[2]-TiO₂(A)_BM”. Here, “[ ]” indicates vanadium atom-based content (unit: wt %), “A” indicates an anatase crystalline phase, and “BM” indicates ball milling

### Preparation Example 2

### Preparation of V[2]-TiO₂(AR)_BM Catalyst

A catalyst was prepared in the same manner as in Preparation Example 1, except that a mixture of crystalline anantase and crystalline rutile (hereinafter, referred to as TiO₂(AR), here, “A” indicates an anatase crystalline phase, and “R” indicates a rutile crystalline phase) was used as a TiO₂ support. The weight ratio of anatase and rutile in TiO₂(AR) was about 75:25. The catalyst prepared in this way is expressed by “V[2]-TiO₂(AR)_BM”.

### Preparation Example 3

### Preparation of V[2]-TiO₂(W)_BM Catalyst

In this Preparation Example, a catalyst was prepared using a TiO₂ support containing 10 wt % of WO₃ (hereinafter, referred to as TiO₂(W), here, “W” indicates tungsten), crystalline phase of which is anatase. A catalyst was prepared in the same manner as in Preparation Example 1, except that TiO₂(W) was used as a TiO₂ support. The catalyst prepared in this way is expressed by “V[2]-TiO₂(W)_BM”.

### Preparation Example 4

### Preparation of V[2]-TiO₂(Mo)_BM Catalyst

In this Preparation Example, a catalyst was prepared using a TiO₂ support containing 10 wt % of MoO₃ (hereinafter, referred to as TiO₂(Mo), here, “Mo” indicates molybdenum), crystalline phase of which is anatase. A catalyst was prepared in the same manner as in Preparation Example 1, except that TiO₂(Mo) was used as a TiO₂ support. The catalyst prepared in this way is expressed by “V[2]-TiO₂(Mo)_BM”.

### Preparation Example 5

### Preparation of V[2]-TiO₂(La)_BM Catalyst

In this Preparation Example, a catalyst was prepared using a TiO₂ support containing 10 wt % of La₂O₃ (hereinafter, referred to as TiO₂(La), here, “La” indicates lanthanum), crystalline phase of which is anatase. A catalyst was prepared in the same manner as in Preparation Example 1, except that TiO₂(La) was used as a TiO₂ support. The catalyst prepared in this way is expressed by “V[2]-TiO₂(La)_BM”.

### Preparation Example 6

### Preparation of V—TiO₂(A)_BM Catalyst According to the Change in the Content of Vanadium

In this Preparation Example, the contents of vanadium to TiO₂ were set to 4 wt %, 6 wt % and 10 wt %, based on vanadium atom. Catalysts were prepared in the same manner as in Preparation Example 1, except that each crystalline V₂O₅ powder was mixed with 20 g of TiO₂(A) in amounts of 1.4284 g, 2.8568 g and 3.5710 g, and then the mixture was ball-milled The catalysts prepared in this way are expressed by “V[4]-TiO₂(A)_BM”, “V[6]-TiO₂(A)_BM” and “V[10]-TiO₂(A)_BM”.

### Preparation Example 7

### Preparation of V—TiO₂(A)_BM Catalyst According to the Change in Ball Milling Time

Catalysts were prepared in the same manner as in Preparation Example 6, except that ball milling time was set to 30 minutes, 1 hour, 3 hours (Preparation Example 6), 10 hours and 24 hours, respectively. The catalysts prepared in this way are expressed by “V[4]-TiO₂(A)_BM(0.5)”, “V[4]-TiO₂(A)_BM(1)”, “V[4]-TiO₂(A)_BM(3)”, “V[4]-TiO₂(A)_BM(10)” and “V[4]-TiO₂(A)_BM(24)”.

### Comparative Preparation Example 1

### Preparation of V[2]/TiO₂(A) Catalyst by Wet Impregnation

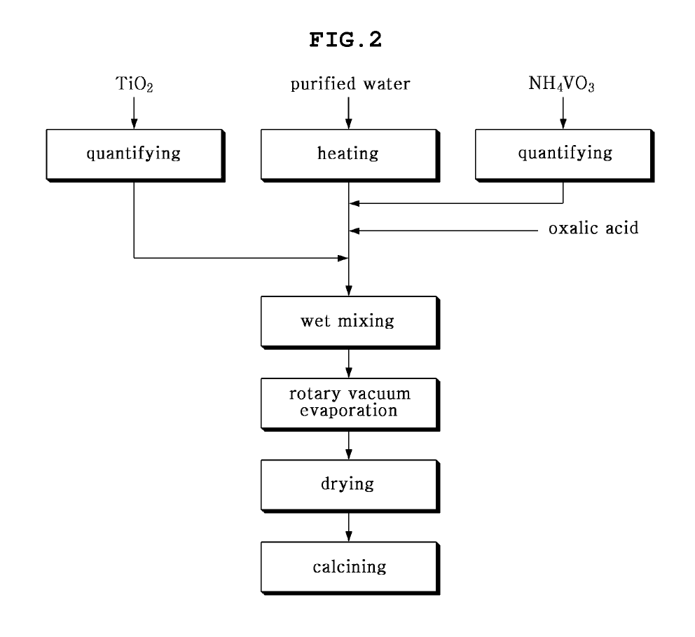

A process of preparing a catalyst by wet impregnation is schematically shown in FIG. 2. A vanadium precursor solution was prepared such that the crystalline vanadium pentoxide (V₂O₅) is used in an amount of 2 wt %, as a calculated value of vanadium atom, based on a total weight of the TiO₂(A). Ammonium metavanadate was used as the vanadium precursor. 0.9186 g of ammonium metavanadate powder was dissolved in 50 mL of distilled water heated to 60° C. to obtain an aqueous solution. In order to increase the solubility of ammonium metavanadate, oxalic acid was gradually added to the aqueous solution while being stirred until the pH of the aqueous solution was 2.5. Then, 20 g of TiO₂(A) powder was gradually mixed with this aqueous solution to form a slurry. This slurry was sufficiently stirred, and then water was removed from the slurry using a rotary vacuum evaporator. Thereafter, in order to additionally remove water from pores in the slurry, the slurry was dried in a drying furnace at 100° C. for 24 hours. Then, the dried slurry was calcined in a tube furnace at 400° C. for 4 hours under an air atmosphere. In this case, the heating rate of the slurry was 10° C./min. The catalyst prepared in this way is expressed by “V[2]/TiO₂(A)”.

### Comparative Preparation Example 2

### Preparation of V[2]/TiO₂(AR) Catalyst by Wet Impregnation

A catalyst was prepared in the same manner as in Comparative Preparation Example 1, except that TiO₂(AR) was used as a TiO₂ support. The catalyst prepared in this way is expressed by “V[2]/TiO₂(AR)”.

### Comparative Preparation Example 3

### Preparation of V[2]/TiO₂(W) Catalyst by Wet Impregnation

A catalyst was prepared in the same manner as in Comparative Preparation Example 1, except that TiO₂(W) was used as a TiO₂ support. The catalyst prepared in this way is expressed by “V[2]/TiO₂(W)”.

### Comparative Preparation Example 4

### Preparation of V[2]/TiO₂(Mo) Catalyst by Wet Impregnation

A catalyst was prepared in the same manner as in Comparative Preparation Example 1, except that TiO₂(Mo) was used as a TiO₂ support. The catalyst prepared in this way is expressed by “V[2]/TiO₂(Mo)”.

### Comparative Preparation Example 5

### Preparation of V[2]/TiO₂(La) Catalyst by Wet Impregnation

A catalyst was prepared in the same manner as in Comparative Preparation Example 1, except that TiO₂(La) was used as a TiO₂ support. The catalyst prepared in this way is expressed by “V[2]/TiO₂(La)”.

### Comparative Preparation Example 6

### Preparation of V[4]/TiO₂(A) Catalyst by Wet Impregnation

A catalyst was prepared in the same manner as in Comparative Preparation Example 1, except that the content ratio of vanadium to TiO₂(A) was increased to 4 wt %. The catalyst prepared in this way is expressed by “V[4]/TiO₂(A)”.

### Comparative Preparation Example 7

### Preparation of V[2]-TiO₂(A)_Mortar Catalyst by Simple Mixing

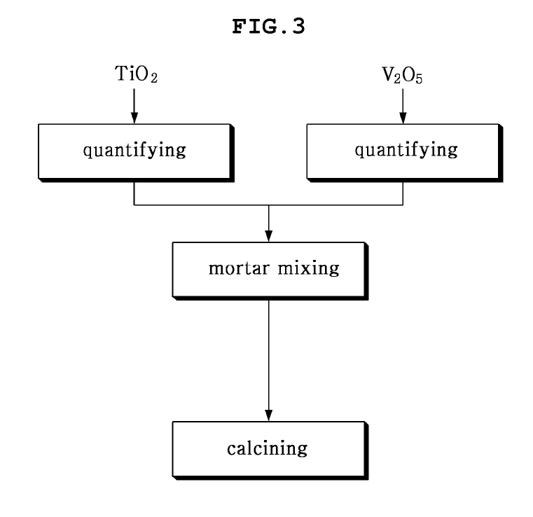

In this Comparative Preparation Example, a catalyst was prepared by mixing TiO₂(A) powder and V₂O₅ powder without using ball milling, and this catalyst was compared with the catalyst prepared in Preparation Example 1. The process of preparing this catalyst is schematically shown in FIG. 3. Specifically, TiO₂(A) powder and V₂O₅ powder were mixed in a mortar in the amounts mentioned Preparation Example 1, and then the mixture was calcined as mentioned in Preparation Example 1. The catalyst prepared in this way is expressed by “V[2]-TiO₂(A)Mortar”.

### Examples 1 to 4

### Tests for Comparing Nitrogen Oxide Removal Activities of Catalysts

Nitrogen oxide removal activities of the catalysts prepared in Preparation Examples 1 to 7 and Comparative Preparation Examples 1 to 7 were evaluated. Tests for activities were carried out at 200, 220, 250, 270 and 300° C. using a catalyst powder tester. The sizes of catalyst particles were uniformly distributed within the range of 300˜425 nm. The volume of catalyst particles was 0.5 mL, and the flow rate of gas flowing into the tester was 500 mL/min. Therefore, gas hourly space velocity was 60,000 hr⁻¹. The concentration of nitrogen oxides in inflowing gas was 400 ppm, the concentration of oxygen therein was 3%, the concentration of water therein was 6%, and the concentration of ammonia therein was 400 ppm.

### Example 1

Nitrogen oxide removal activities of the catalysts prepared in Preparation Examples 1 to 5 and Comparative Preparation Examples 1 to 5 were evaluated at 200, 220, 250, 270 and 300° C., and the results thereof are given in Table 1 below.

TABLE 1

| | | Removal rate of nitrogen oxides (%) | | | | |
|---|---|---|---|---|---|---|
| Prep. Examples | Catalysts | 200° C. | 220° C. | 250° C. | 270° C. | 300° C. |
| Prep. Example 1 | V[2]-TiO₂(A)_BM | 41 | 56 | 85 | 93 | 95 |
| Comp. Prep. Example 1 | V[2]/TiO₂(A) | 39 | 55 | 85 | 94 | 95 |
| Prep. Example 2 | V[2]-TiO₂(AR)_BM | 38 | 54 | 82 | 92 | 94 |
| Comp. Prep. Example 2 | V[2]/TiO₂(AR) | 35 | 49 | 80 | 89 | 93 |
| Prep. Example 3 | V[2]-TiO₂(W)_BM | 43 | 70 | 92 | 100 | 100 |
| Comp. Prep. Example 3 | V[2]/TiO₂(W) | 38 | 58 | 88 | 96 | 100 |
| Prep. Example 4 | V[2]-TiO₂(Mo)_BM | 46 | 66 | 92 | 95 | 100 |
| Comp. Prep. Example 4 | V[2]/TiO₂ (Mo) | 34 | 53 | 86 | 91 | 95 |
| Prep. Example 5 | V[2]-TiO₂(La)_BM | 25 | 31 | 43 | 55 | 88 |
| Comp. Prep. Example 5 | V[2]/TiO₂(La) | 17 | 19 | 24 | 31 | 46 |

As given in Table 1 above, it can be ascertained that the nitrogen oxide removal rate of the catalyst of Preparation Example 1, using TiO₂(A) as a support, at 200˜300° C. was similar to or somewhat higher than that of the catalyst of Comparative Preparation Example 1. However, in terms of a preparation process, the catalyst of Preparation Example 1 is prepared by a much simpler process compared to the catalyst of Comparative Preparation Example 1 and does not require a drying process, so the energy consumption used in the preparation of a catalyst can be reduced, thereby increasing economical efficiency.

Meanwhile, it can be ascertained that the nitrogen oxide removal rate of the catalyst of Preparation Example 2, using TiO₂(AR) containing anatase and rutile as a support, was higher than that of the catalyst of Comparative Preparation Example 2 by 1˜5%. Further, it can be ascertained that the nitrogen oxide removal rate of the catalyst of Preparation Example 3, using TiO₂(W) containing tungsten as a support, was higher than that of the catalyst of Comparative Preparation Example 3 by a maximum of 12%. Further, it can be ascertained that the nitrogen oxide removal rate of the catalyst of Preparation Example 4, using TiO₂(Mo) containing molybdenum as a support, was higher than that of the catalyst of Comparative Preparation Example 4 by 4˜13%, and that the nitrogen oxide removal rate of the catalyst of Preparation Example 5, using TiO₂(La) containing lanthanum as a support, was higher than that of the catalyst of Comparative Preparation Example 5 by 8˜42%.

Consequently, it can be ascertained that, on the basis of a catalyst supported with the same amount of vanadium, the catalyst prepared according to the present invention has higher nitrogen oxide removal activity than that of the conventional catalyst prepared by wet impregnation.

### Example 2

### Comparison of Nitrogen Oxide Removal Activities According to the Content of Vanadium

Nitrogen oxide removal activities of the catalysts prepared in Preparation Examples 1 and 6 and Comparative Preparation Examples 1 and 6 were evaluated at 200, 220, 250, 270 and 300° C., and the results thereof are given in Table 2 below.

TABLE 2

| | | Removal rate of nitrogen oxides (%) | | | | |
|---|---|---|---|---|---|---|
| Prep. Examples | Catalysts | 200° C. | 220° C. | 250° C. | 270° C. | 300° C. |
| Prep. Example 1 | V[2]-TiO₂(A)_BM | 41 | 56 | 85 | 93 | 95 |
| Prep. Example 6 | V[4]-TiO₂(A)_BM | 79 | 93 | 95 | 95 | 95 |
| | V[6]-TiO₂(A)_BM | 82 | 93 | 95 | 95 | 95 |
| | V[10]-TiO₂(A)_BM | 81 | 94 | 95 | 95 | 95 |
| Comp. Prep. Example 1 | V[2]/TiO₂(A) | 39 | 55 | 85 | 94 | 95 |
| Comp. Prep. Example 6 | V[4]/TiO₂(A) | 76 | 88 | 92 | 92 | 94 |

As given in Table 2 above, it can be ascertained that the nitrogen oxide removal rate of the catalyst of Preparation Example 1 was similar to or somewhat higher than that of the catalyst of Comparative Preparation Example 1. Further, it can be ascertained that, when the content of vanadium was 4 wt %, the nitrogen oxide removal rate of the catalyst V[4]-TiO₂(A)_BM of Preparation Example 6 was higher than that of the catalyst V[4]/TiO₂(A) of Comparative Preparation Example 6 by 1˜5%.

### Example 3

### Comparison of Nitrogen Oxide Removal Activities According to Ball Milling Time

Nitrogen oxide removal activities of the catalysts prepared in Preparation Example 7 and Comparative Preparation Examples 6 and 7 were evaluated at 200, 220, 250, 270 and 300° C., and the results thereof are given in Table 3 below. Here, since the catalyst of Comparative Preparation Example 7 was prepared by mixing V₂O₅ and TiO₂(A) in a mortar and immediately calcining the mixture, ball milling time is 0.

TABLE 3

| | | Removal rate of nitrogen oxides (%) | | | | |
|---|---|---|---|---|---|---|
| Prep. Examples | Catalysts | 200° C. | 220° C. | 250° C. | 270° C. | 300° C. |
| Prep. Example 7 | V[4]-TiO₂(A)_BM(0.5) | 28 | 43 | 66 | 81 | 84 |
| | V[4]-TiO₂(A)_BM(1) | 44 | 62 | 86 | 92 | 93 |
| | V[4]-TiO₂(A)_BM(3) | 79 | 93 | 95 | 95 | 95 |
| | V[4]-TiO₂(A)_BM(10) | 79 | 92 | 95 | 95 | 95 |
| | V[4]-TiO₂(A)_BM(24) | 82 | 93 | 93 | 94 | 94 |
| Comp. Prep. Example 6 | V[4]/TiO₂(A) | 76 | 88 | 92 | 92 | 94 |
| Comp. Prep. Example 7 | V[4]-TiO₂(A)_Mortar | 19 | 20 | 29 | 39 | 55 |

As given in Table 3 above, it can be ascertained that the nitrogen oxide removal rate of the catalyst became higher according to the increase in ball milling time. Therefore, it is preferred that ball milling be carried out for 3 hours or more in order to obtain a catalyst having a higher nitrogen oxide removal rate than that of the catalyst of Comparative Preparation Example 6 prepared by wet impregnation. However, it is significant that, even when ball milling time is less than 3 hours, a catalyst can be prepared by a very simple process, compared to the wet impregnation of Comparative Preparation Example 6.

The efficiency of the catalyst of Comparative Preparation Example 7 was lower than that of Comparative Preparation Example 6 as well as that of Preparation Example 7. Therefore, it can be ascertained that an excellent denitrification catalyst cannot be obtained by simple mixing of V₂O₅ and TiO₂ without using ball milling.

### Example 4

### X-Ray Diffraction Analysis

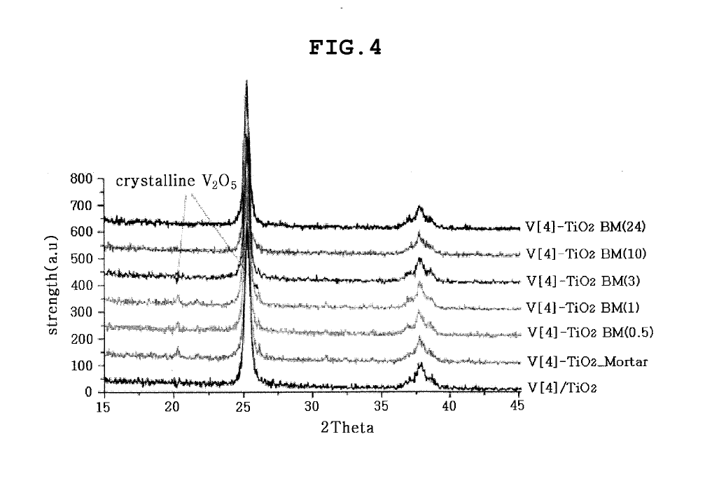

In order to observe the crystal structures of the catalysts prepared in Preparation Example 7 and Comparative Preparation Examples 6 and 7, crystal structure analysis was performed using X-ray diffraction (XRD). The XRD patterns thereof were analyzed by a X-ray diffractometer (D/Max-BI(3 kW), manufactured by Rigaku Corp.). Cu Kα(λ=0.1506 nm) was used as a X-ray radiation source. The XRD patterns thereof were measured in the range of 2θ=10˜90° at a scanning rate of 4°/min, and the results thereof are shown in FIG. 4.

As shown in FIG. 4, in the catalysts V[4]-TiO₂ BM(0.5) and V[4]-TiO₂ BM(1) of Preparation Example 7 and the catalyst of Comparative Preparation Example 7, each nitrogen oxide removal rate of which is lower than that of the catalyst V[4]/TiO₂(A)of Comparative Preparation Example 6, the peaks of crystalline vanadium V₂O₅ are discovered at a point where 2 theta is about 20.29°. However, in the catalysts V[4]-TiO₂ BM(3), V[4]-TiO₂ BM(10) and V[4]-TiO₂ BM(24) of Preparation Example 7, each nitrogen oxide removal rate of which is higher than that of the catalyst V[4]/TiO₂(A) of Comparative Preparation Example 6, the peaks of crystalline vanadium V₂O₅ are not discovered. The reason for this is presumed that crystalline V₂O₅ is pulverized by ball milling for a predetermined amount of time to be uniformly dispersed on the surface of a support, thus forming amorphous V₂O₅.

1. A method of preparing a catalyst for removing nitrogen oxides, comprising the steps of:
mixing crystalline titanium dioxide (TiO₂) powder and crystalline vanadium pentoxide (V₂O₅) powder to obtain a mixture;
subjecting the mixture to a dry ball milling process; and
calcining the ball-milled mixture.

2. The method of claim 1, wherein the crystalline titanium dioxide (TiO₂) is in the form of anatase crystals or in the form of anatase/rutile mixed crystals.

3. The method of claim 1, wherein the crystalline titanium dioxide (TiO₂) additionally includes at least one selected from the group consisting of tungsten, molybdenum and lanthanum.

4. The method of claim 1, wherein the crystalline vanadium pentoxide (V₂O₅) is used in an amount of 0.1˜5 wt %, as a calculated value of vanadium atom, based on a total weight of the crystalline titanium dioxide (TiO₂).

5. The method of claim 1, wherein the step of subjecting the mixture to a dry ball milling process is performed at a ball powder mass ratio (BPMR) of 1:1˜100:1 at a rotation speed of 10˜1000 rpm for 0.5˜24 hours.

6. The method of claim 1, wherein the step of calcining the ball-milled mixture is performed in a calcining furnace at a temperature of 300˜800° C. for 4˜12 hours under an air or oxygen atmosphere.

7. The method of claim 1, wherein the catalyst is a catalyst for removing nitrogen oxides using selective catalytic reduction.

8. A method of removing nitrogen oxides from exhaust gas containing nitrogen oxides using selective catalytic reduction in the presence of the catalyst prepared by the method of claim 1 and a reducing agent.
